(19) United States
(12) Patent Application Publication
(10) Pub. No.: US 2014/0139690 A1
(43) Pub. Date: May 22, 2014

(54) INFORMATION PROCESSING APPARATUS, CAMERA HAVING COMMUNICATION FUNCTION, AND INFORMATION PROCESSING METHOD

(71) Applicant: KABUSHIKI KAISHA TOSHIBA, Tokyo (JP)

(72) Inventors: Yasuyuki TANAKA, Chigasaki-Shi (JP); Yoshihiro OBA, Kawasaki-Shi (JP); Mitsuru KANDA, Tokyo (JP); Seijiro YONEYAMA, Yokohama-Shi (JP); Takaomi MURAKAMI, Kawasaki-Shi (JP); Tatsuo KOZAKAYA, Kawasaki-Shi (JP); Ryuzo OKADA, Kawasaki-Shi (JP); Tomoki WATANABE, Kawasaki-Shi (JP)

(73) Assignee: KABUSHIKI KAISHA TOSHIBA, Tokyo (JP)

(21) Appl. No.: 14/082,305

(22) Filed: Nov. 18, 2013

(30) Foreign Application Priority Data
Nov. 20, 2012 (JP) 2012-254364

(51) Int. Cl. H04N 1/00; H04L 29/08; G06K 9/00

(52) U.S. Cl. CPC H04N 1/00217; G06K 9/00288; H04L 29/08135
USPC 348/207.11; 709/201

(57) ABSTRACT

An information processing apparatus has a communication part, a message receiving part, a network-information acquiring part, a peripheral-apparatus information managing part, a task accepting part, a task allocating part, a task processing part, a process-related information generating part, and a message transmitting part configured to generate a message that includes the process-related information and transmit the message including the process-related information to the other communication apparatuses via the communication part and the network.

### CROSS REFERENCE TO RELATED APPLICATIONS

This application is based upon and claims the benefit of priority from the prior Japanese Patent Application No. 2012-254364, filed on Nov. 20, 2012, the entire contents of which are incorporated herein by reference.

### FIELD

Embodiments of the present invention relate to an information processing apparatus for performing tasks by distributed processing, a camera having a communication function, and an information processing method.

### BACKGROUND

A technique to distribute and execute image processing has been proposed in which a plurality of image processing apparatuses connected to a network are used.

As an example of image processing, a technique to recognize a human face contained in an image captured by a camera and automatically determine whether the recognized face matches a particular person has also been proposed.

In a conventional technique, in order to distribute and execute image processing, a controller is provided to determine how to distribute image processing, and the controller decides the apparatus to which image processing is allocated. Therefore, there is a problem in that a controller is essential in addition to an apparatus for distributed processing for image processing, resulting in complicating a system structure.

Upon executing a process of recognizing human faces contained in an image or a process of determining whether a recognized face matches a particular person, the processing load of an image processing apparatus increases as the number of human faces contained in an image increases. When distributing and executing this kind of image processing with a plurality of image processing apparatuses connected to a network, not only the processing capability and processing conditions of each image processing apparatus, but also the network load such as a communication time from a requester to a requestee has to be considered.

However, the conventional techniques do not have an idea to distribute image processing under total consideration of the processing capability and processing conditions of each image processing apparatus and the network load.

### BRIEF DESCRIPTION OF THE DRAWINGS

FIG. 1 is a block diagram schematically showing the configuration of an information processing apparatus 1 according to an embodiment;

FIG. 2 is a view of a network structure in the present embodiment;

FIG. 3 is a view showing a concrete structure of a network 20;

FIG. 4 is a block diagram schematically showing the configuration of a monitoring camera 1a;

FIG. 5 is a view showing an example of information stored in a peripheral-device DB 11.

FIG. 6 is a flowchart showing an example of process steps of a task allocating part 7 of its own node;

FIG. 7 is a view of an example of a network structure different from FIG. 2;

FIG. 8 is a view of an example of error output; and

FIG. 9 is a view of a network structure according to a sixth embodiment;

### DETAILED DESCRIPTION

According to one embodiment, an information processing apparatus has a communication part configured to communicate with other communication apparatuses via a network, a message receiving part configured to receive messages distributed to the network by the other communication apparatuses, via the communication part, a network-information acquiring part configured to acquire network information on communication with the other communication apparatuses which has transmitted the messages received by the message receiving part, a peripheral-apparatus information managing part configured to manage the network information acquired by the network-information acquiring part and the message received by the message receiving part, for each of the other communication apparatuses connected to the network, a task accepting part configured to accept tasks requested by the other communication apparatuses via the communication part, a task allocating part configured, based on the messages received by the message receiving part and the network information, to allocate tasks to be performed and to request the other communication apparatus for a task allocated to the other communication apparatus via the communication part, a task processing part configured to execute a task allocated by the task allocating part, a process-related information generating part configured to generate process-related information that includes at least one of a processing capability of the task processing part and a processing load of the task processing part, and a message transmitting part configured to generate a message that includes the process-related information and transmit the message including the process-related information to the other communication apparatuses via the communication part and the network.

Embodiments will now be explained with reference to the accompanying drawings.

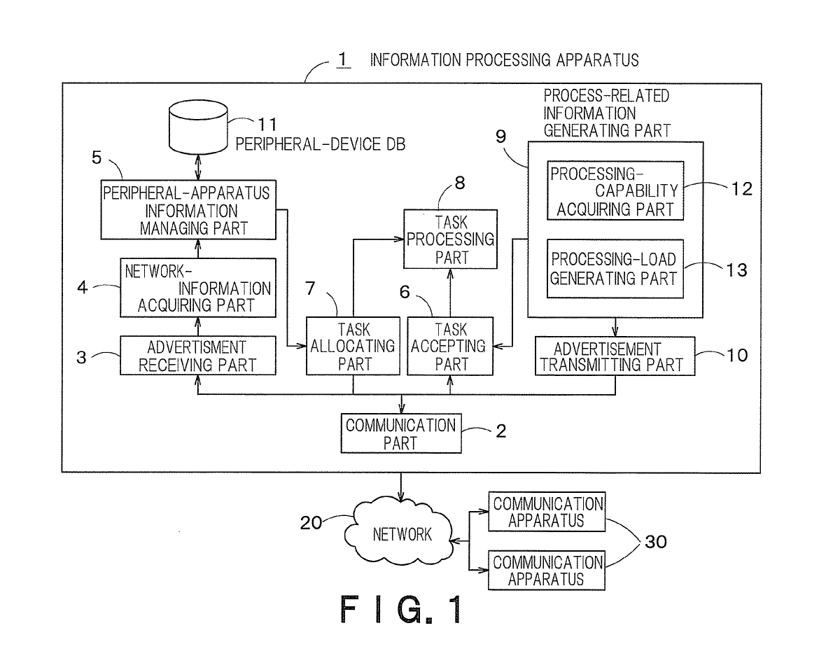

FIG. 1 is a block diagram schematically showing the configuration of an information processing apparatus 1 according to an embodiment. The information processing apparatus 1 of FIG. 1 is provided with a communication part 2, an advertisement receiving part (message receiving part) 3, a network-information acquiring part 4, a peripheral-apparatus information managing part 5, a task accepting part 6, a task allocating part 7, a task processing part 8, a process-related information generating part 9, and an advertisement transmitting part (message transmitting part) 10.

The communication part 2 communicates with other communication apparatuses 30 via a network 20. The advertisement receiving part 3 receives an advertisement message distributed to the network from another communication apparatuses 30, via the communication part 2.

The network-information acquiring part 4 acquires network information on communication with the other communication apparatuses 30 which transmitted the advertisement message received by the advertisement receiving part 3. The network information includes information on network connection with other communication nodes that communicate with its own node, a connection mode, communication quality, a communication band, a signal delay, an error rate, the number of hops, signal strength, etc. The network information will be explained later in detail.

The peripheral-apparatus information managing part 5 manages the network information acquired by the network-information acquiring part 4 and the contents of the advertisement message received by the advertisement receiving part 3, for each of the other communication apparatuses 30 connected to the network 20. The network information and the contents of the advertisement message for each communication apparatus are linked together and stored in a peripheral-apparatus database (peripheral-device DB) 11.

The task accepting part 6 accepts a task requested by another communication apparatus 30 via the communication part 2. The task allocating part 7 performs the allocation of tasks to be performed based on the advertisement message and network information received by the advertisement receiving part 3 and requests another communication apparatus 30 for performing a task allocated to the other communication apparatus 30. The task processing part 8 executes a task allocated to itself by the task allocating part 7 and a task accepted by the task accepting part 6.

The process-related information generating part 9 generates process-related information including at least one of the processing capability of the task processing part 8 and the processing load of the task processing part 8.

The advertisement transmitting part 10 generates an advertisement message containing the process-related information and advertises the advertisement message to the other communication apparatuses 30 via the communication part 2 and the network 20.

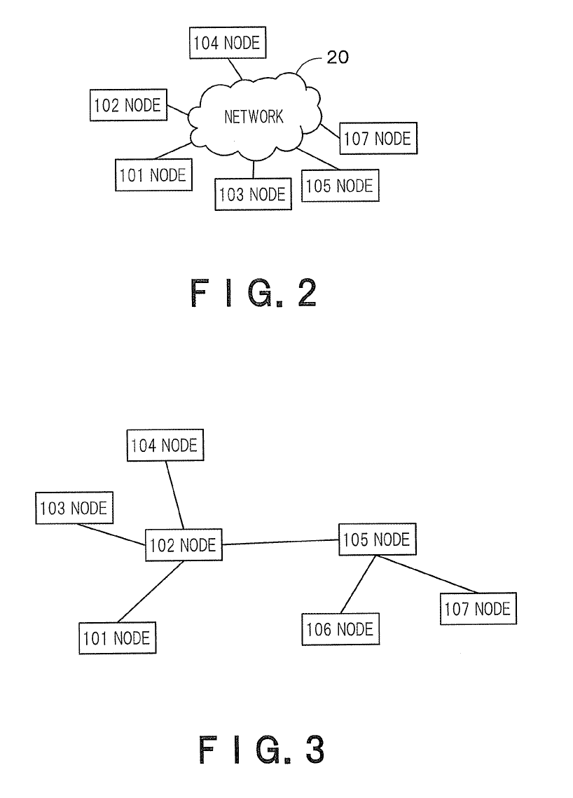

This embodiment assumes that a plurality of communication apparatuses are connected to the network 20, in addition to the information processing apparatus 1 of FIG. 1. In a network structure, the information processing apparatus 1 and each communication apparatus can be regarded as communication nodes. Therefore, a view of a network structure in this embodiment is such as shown in FIG. 2.

Although, no specific structure of the network 20 is shown in FIG. 2, the structure such as shown in FIG. 3 is considered as a concrete example. In the example of FIG. 3, each of communication nodes 101, 103 and 104 communicates with a communication node 102, and each of communication nodes 106 and 107 communicates with a communication node 105. When the communication nodes 102 and 105 communicate with each other, all of the other communication nodes can freely communicate with one another via the communication nodes 102 and 105.

As described above, the communication nodes shown in FIGS. 2 and 3 form a routing topology. The routing topology may be a static routing topology or a dynamic routing topology in which routing paths can be changed freely depending on communication conditions. The techniques that can be adopted to form a dynamic routing topology are RPL (IPv6 Routing Protocol for Low Power and Lossy Networks), AODV (Ad Hoc On-Demand Distance Vector) routing, OLSR (Optimized Link State Routing Protocol), etc. Other routing topologies may also be adopted.

Each of the communication nodes 101 to 107 shown in FIG. 3 is the information processing apparatus 1 or one of the other communication apparatuses 30 connected to the network 20, in FIG. 1. The other communication apparatus 30 may include various types of communication equipment having a communication function such as a server and a relay device. Hereinbelow, an example of executing a task distribution process will be explained, in which the other communication apparatuses 30 have a function similar to the information processing apparatus 1 of FIG. 1.

There is no limitation to the contents of a process of a task in this embodiment. Hereinbelow, image processing will be explained as an example of a task.

The information processing apparatus 1 and the other communication apparatuses 30 in FIG. 1 are, for example, monitoring cameras that are connected to one another via a network. In this embodiment, for example, a task for recognizing human faces contained in an image captured by one monitoring camera and a task for determining the gender from recognized faces to calculate the number of humans in the image for each gender are distributed and executed by a plurality of monitoring cameras connected to the network 20. For example, in FIG. 3, each communication node may be a monitoring camera. In this case, a monitoring camera that has captured an image may perform a task of image processing by itself. Or the monitoring camera that has captured the image may send data for image processing to monitoring cameras of other communication nodes to share image processing.

In a more specific example, it is expected that an image captured by a monitoring camera installed in a place where many people pass such as a busy street contains many human faces in a specific time zone. Therefore, it takes a long time for the monitoring camera alone to analyze the captured image to perform image processing such as face recognition and gender determination. Then, in this example, the other plurality of monitoring cameras connected to the same network 20 share image processing, so that face recognition and gender determination can be done in a relatively short time.

As describe above, a plurality of monitoring cameras connected to the same network 20 share a task of image processing. By way of this task sharing, even if the number of passersby varies largely, depending on the time zone, around the place where each monitoring camera has been installed, a monitoring camera that cannot accomplish a task of image processing due to a large number of passersby can request a monitoring camera with a low processing load due to a small number of passersby, for task processing. In this way, image processing can be completed in a short time.

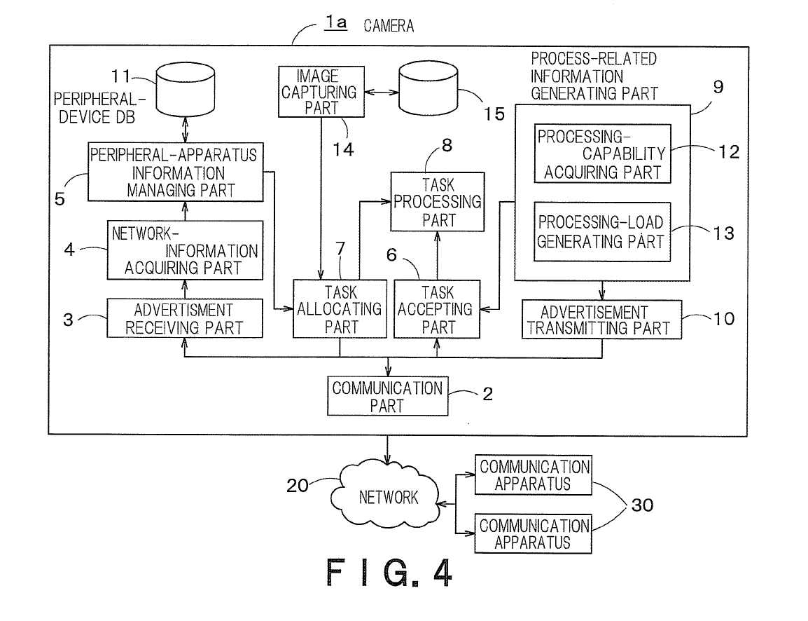

When the information processing apparatus 1 of FIG. 1 is a monitoring camera 1a, as shown in FIG. 4, it requires at least an image capturing part 14 and a storage part 15 for storing captured images in addition to those shown in the block diagram of FIG. 1. The image capturing part 14 captures at least one of moving images and still images.

When the information processing apparatus 1 of FIG. 1 is a monitoring camera 1a, the task allocating part 7 performs task allocation for image processing and then the task processing part 8 executes a task of image processing allocated by the task allocating part 7. The process-related information generating part 9 generates process-related information that includes at least one of the image processing capability of the task processing part 8 and the processing load of the task processing part 8 at the time of image processing. Moreover, according to need, the task allocating part 7 decides to request a monitoring camera connected to the network 20 for at least part of image processing related to the images captured by the image capturing part 14 and transmits an instruction message concerning the image processing via the communication part 2.

The information processing apparatus 1 and the other communication apparatuses 30 in this embodiment have the same configuration as those shown in the block diagram of FIG. 1. The process-related information generating part 9 in each of these apparatuses has, for example, a processing-capability acquiring part 12 and a processing-load generating part 13, as shown in FIG. 1. The processing-capability acquiring part 12 acquires a processing capability unique to the apparatus, which is not affected by a processing load. The processing capability, here, means hardware configuration information, hardware performance, etc. of the apparatus itself, for example. The processing-load generating part 13 generates dynamic processing load information that varies depending on the processing load of the apparatus itself. The processing load information includes at least one among the current processing load of the apparatus itself, the tendency of processing load, and the prediction of future processing load. The tendency of processing load is information on tendency as to whether the processing load tends to increase or decrease as time elapses, information on processing load and time, for example, a time zone, a day or a month with a higher processing load, etc.

The processing-load generating part 13 generates process-related information that includes those processing capabilities unique to the apparatus and dynamic processing load information. The process-related information may not always necessary to include both of the processing capability unique to the apparatus and dynamic processing load information, but may include either one.

The process-related information generated by the processing-capability acquiring part 12 and the processing-load generating part 13 is advertised to information processing apparatuses 1 or communication apparatuses 30 of other communication nodes via the advertisement transmitting part 10 and the network 20. Then, the information processing apparatus 1 or the communication apparatus 30 of each communication node receives an advertisement message containing process-related information advertised by another communication node, at the advertisement receiving part 3. The process-related information contained in the advertisement message is sent to the network information acquiring part 4. The network-information acquiring part 4 acquires network information on communication with the information processing apparatus 1 or the other communication apparatus 30 of the communication node that has advertised the process-related information. The network information includes a connection mode with another communication node, communication quality, a communication delay, an error rate, the number of hops, signal strength, etc. These kinds of information are a just an example. Only part of these kinds of information or other information may be included in the network information. The network information and the process-related information are stored in the peripheral-device DB 11 in association with the information processing apparatus 1 or the communication apparatus 30 that is the communication node that has advertised the process-related information.

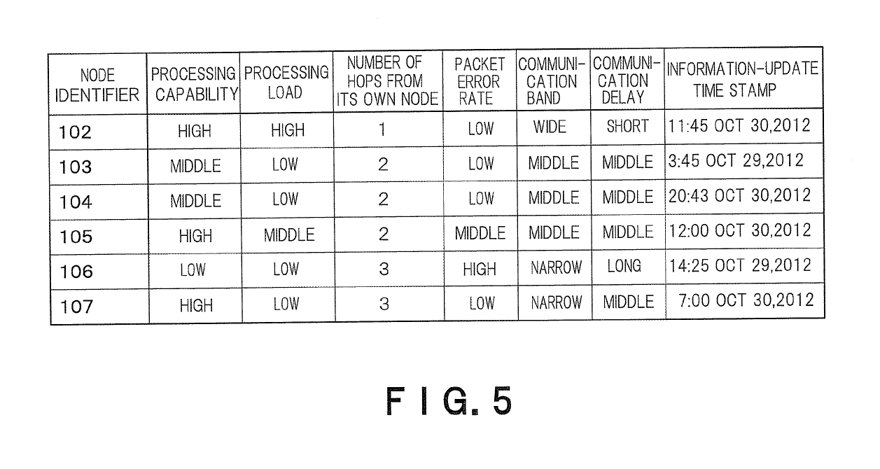

FIG. 5 is a view showing an example of information stored in the peripheral-device DB 11. In this example, a plurality of pieces of network information have been registered in the peripheral-device DB 11 in association with communication node identifiers for identifying each of the information processing apparatus 1 and the communication apparatuses connected to the network 20. The registered pieces of network information are, for example, a processing capability, a processing load, the number of hops from its own node, a packet error rate, a communication band, a communication delay, and an elapsed time (time stamp) from the date of updating information.

Hereinbelow, it is supposed that the information processing apparatus 1 of FIG. 1 is located at its own node and the other communication apparatuses 30 are located at its peripheral nodes, and each of the information processing apparatus 1 and the other communication apparatuses 30 has the same configuration as shown in FIG. 1.

The task allocating part 7 at its own node accesses network information and process-related information stored in the peripheral-device DB 11 to decide a task of image processing to be assigned to another communication apparatus at a peripheral node. In more detail, the task allocating part 7 determines whether to perform, at its own node, image processing of image data acquired from a camera or the like or request a peripheral node for the image processing and also determines what kind of transaction (task) to request if requesting a peripheral node.

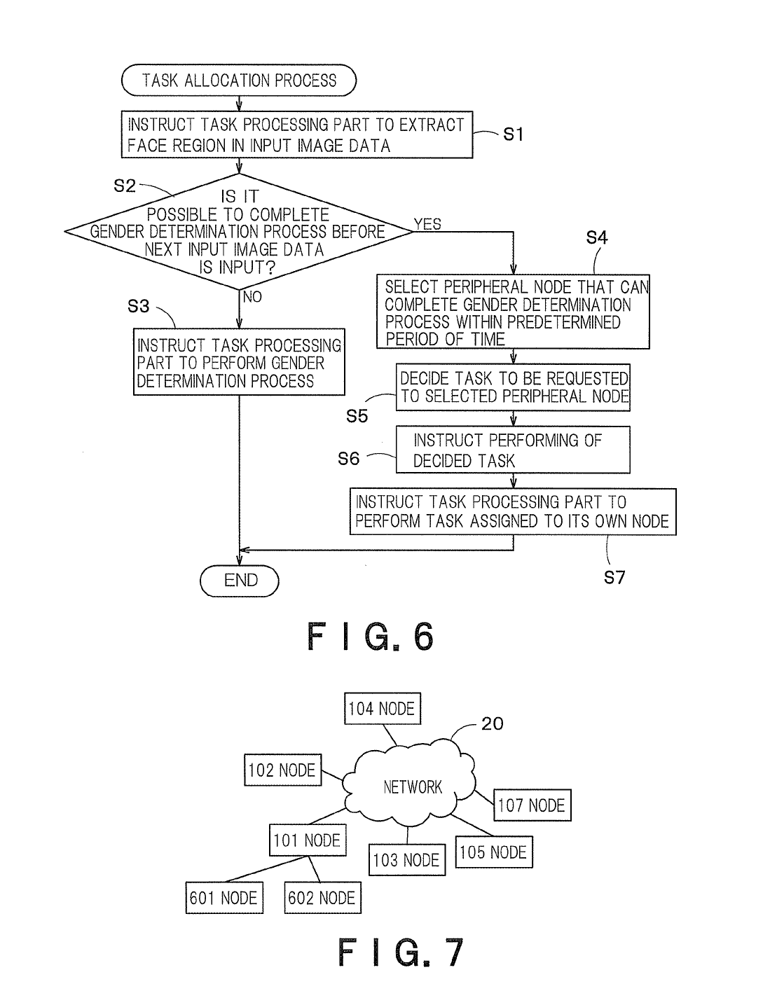

Next, process steps of the task allocating part 7 will be explained with an example of calculating the number of men and women contained in an image. FIG. 6 is a flowchart showing an example of process steps of the task allocating part 7 at its own node.

Firstly, the task allocating part 7 instructs the task processing part 8 to extract a face region in input image data (step 1). Based on a result of process by the task processing part 8, the task allocating part 7 determines whether it is possible to complete a gender determination process at its own node before the next input image data is input (step S2). In this step S2, whether the gender determination process can be completed is determined by the number of face regions contained in an image, the processing capability at its own node, the processing load at its own node, etc.

If it is determined that the gender determination process can be completed at its own node, the task allocating part 7 instructs the task processing part 8 to perform the gender determination process (step S3), and ends the process of FIG. 6.

On the other hand, if it is determined that the gender determination process cannot be completed at only its own node, the task allocating part 7 acquires network information and process-related information of the peripheral nodes from the peripheral-apparatus information managing part 5 to select a peripheral node that can complete the gender determination process within a predetermined period of time (step S4).

When performing the process of step S4, the task allocating part 7 estimates a processing time for the case where a peripheral node performs the gender determination process, based on the processing capability and processing load of the peripheral node, that can be acquired from the peripheral-apparatus information managing part 5. Moreover, based on the network information, the task allocating part 7 detects a bandwidth, a communication delay, etc. on a communication path from its own node to a peripheral node to estimate a communication time required for transmitting and receiving image data between its own node and the peripheral node. The estimation processes may be performed for all peripheral nodes or some peripheral nodes. Next, the task allocating part 7 gives an order of priority to the peripheral nodes based on the estimated processing time and communication time. The order of priority is determined under consideration of not only the estimated processing time and communication time but also a predetermined specific policy. The specific policy may be a policy to give a higher priority to a peripheral node of a smaller total amount of processing and communication times, a policy to prioritize the shortness of processing time rather than the shortness of communication time to give a higher priority to a peripheral node of a shorter processing time among peripheral nodes of the same communication time, etc. A variety of policies can be considered according to the need of the system of the network 20.

Next, the task allocating part 7 decides a task to be requested to the peripheral node selected in step S4 (step S5). For example, the task allocating part 7 requests different peripheral nodes to perform the gender determination process for each of a plurality of face regions contained in input image data and, in step S5, decides the face region for which the gender determination process is requested to the peripheral node selected in step S4.

Next, the task allocating part 7 transmits an instruction message indicative of performing the task decided in step S5, to the peripheral node selected in step S4 (step S6). The instruction message may contain information on the time for completing the assigned task.

Next, the task allocating part 7 instructs the task processing part 8 to perform the task assigned to its own node (step S7).

The communication apparatus of the peripheral node that has received the instruction message of step S6 analyses the instruction message by its internal task accepting part 6. Then, the communication apparatus determines whether to perform the requested task under consideration of a processing capability, a processing load, etc. of its own communication node. When performing the requested task, the communication apparatus instructs the task processing part 8 of its node to perform the task. When not performing the requested task, the communication apparatus transmits a request rejection message to the information processing apparatus 1 or the communication apparatus 30 that is the node that has transmitted the instruction message.

A result of performing a task requested by the information processing apparatus 1 or the communication apparatus 30 of any communication node may or may not be returned to that node. How to handle the result may be contained in an instruction message at the time of a task request or may be notified by a certain technique beforehand.

As described above, in the first embodiment, when a plurality of tasks such as image processing cannot be executed within a certain period by its own its own node, the tasks can be allocated to peripheral nodes, so that a plurality of communication nodes can cooperate one another to execute the tasks in a short time. When tasks are allocated to peripheral nodes, it is determined which task is assigned to which peripheral node based on network information between the its own node and the peripheral nodes, and process-related information of the peripheral nodes. Therefore, task allocation can be decided under consideration of a processing capability, a processing load, etc. of its own node and the peripheral nodes or a communication band, a communication delay, etc. between its own node and the peripheral nodes. Accordingly, optimum task allocation can be performed.

According to the present embodiment, all of the communication nodes connected to the network 20 perform tasks by distributed processing while communicating with one another. Therefore, there is no need to provide an equipment such as a server for overall control of all communication nodes, so that the network structure can be simplified. Accordingly, for example, by sharing the execution of image processing among a plurality of peripheral monitoring cameras, a process of determining the gender of people contained in a captured image to detect the number of men and women can be done in a short time.

### Second Embodiment

In the first embodiment described above, an example has been explained in which the advertisement transmitting part 10 transmits an advertisement message containing process-related information on its own node to the network 20. This advertisement message may be contained in a message of a routing protocol for constructing, managing and maintaining a routing topology among a plurality of communication nodes.

At least some communication nodes among those connected to the network 20 may not be capable of communicating with one other. For example, in the case of network structure of FIG. 7, communication nodes 601 and 602 can communicate only with a communication node 101. The communication nodes 601 and 602 are used for load balancing.

### Third Embodiment

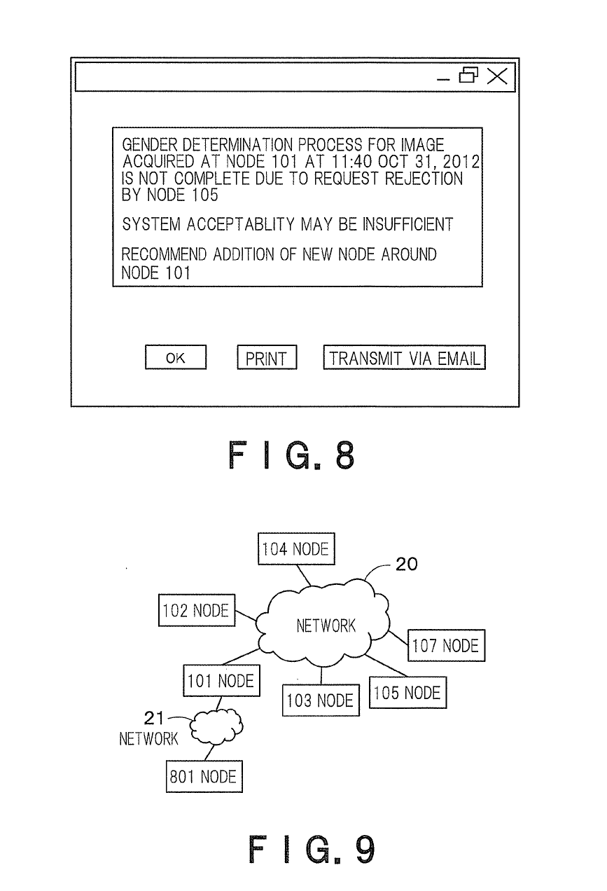

When a node receives a rejection response from a peripheral node to which the node has requested a task, the task allocating part 7 in the information processing apparatus 1 or the communication apparatus 30 of the requesting node performs a process of selecting a substitute peripheral node based on network information managed by the peripheral-apparatus information managing part 5. If there is no substitute peripheral node, it is preferable for the task allocating part 7 to make an error log, output an error via a man-machine interface as shown in FIG. 8, etc.

### Fourth Embodiment

When image processing is performed to a captured image, a slant correction process may have to be performed to the captured image before performing main image processing (for example, a face-region detection process, a gender determination process, etc.). In this case, if the same image processing is repeated by varying the slant correction angle a plurality of times, the processing load increases very much. It is then preferable for its own node to request the information processing apparatus 1 or the communication apparatuses of peripheral nodes for slant angle correction different for each peripheral node and the following image processing. In this way, its own node can know in a short time at what slant correction angle the optimum image processing can be performed, without extremely heavy processing load to its own node.

### Fifth Embodiment

The processing-capability acquiring part 12 at its own node acquires the processing capability unique to the apparatus at its own node. If there is a function that can be used by peripheral nodes among functions at its own node, it may be arranged so that the function can be used by the peripheral nodes.

For example, it is supposed that its own node has a function of extracting a feature value of input image data at high speed. In this case, it is considered that its own node contains information indicating that its own node has a high-speed feature-value extracting function in an advertisement message and advertises to peripheral nodes with the advertisement message. Based on the advertisement, when the task allocating part 7 of a communication node requires a task to extract a feature value, the task allocating part 7 can request a peripheral node that has the high-speed feature-value extracting function for performing the task.

In addition to the feature value extraction described above, the fifth embodiment may be applied to the case in which, if there is a communication node having high-end database dictionary function, a task of searching a database may be requested to the communication node.

### Sixth Embodiment

In a sixth embodiment which will be explained below, the task allocating part 7 performs task allocation under consideration of communication cost.

FIG. 9 is a view of a network structure according to a sixth embedment. In FIG. 9, there are two types of networks 20 and 21. A node 801 is connected to the network 21 only. A node 101 is connected to both of the networks 20 and 21. The other nodes 102 to 107 are connected to the network 20 only.

The network 20 is, for example, a local network such as LAN. The network 21 is, for example, a public mobile phone network. A communication cost for communication via the network 20 is based on a fixed rate, for example. A communication cost for communication via the network 21 is based on a measured rate in accordance with the amount of packets, for example.

In the network structure described above, it is supposed that the information processing apparatus 1 or the communication apparatus 30 of the node 101 allocates tasks to the peripheral nodes. In this case, the peripheral-apparatus information managing part 5 of the node 101 incorporates a cost for communication with the peripheral nodes in network information. Then, the task allocating part 7 performs task allocation so that the communication cost can be reduced as much as possible under consideration of the communication cost for requesting tasks to the peripheral nodes 102 to 107 and 801. For example, the task allocating part 7 performs task allocation in such a manner that tasks are not allocated to the node 801 as much as possible and, even if required, a task with a smaller amount of data is allocated to the node 801 so that it costs less for communication.

### Seventh Embodiment

In the first to sixth embodiments described above, examples of image processing to extract face regions from a pictured or acquired target image and perform a gender determination process have been explained. In addition, the present invention is applicable to another type of image processing.

For example, it may be performed to extract a face region from a target image and perform a determination process concerning the age, race, face orientation, eye orientation, etc. Or it may be performed to extract a face region from a target image and perform matching with a particular person or group. Matching with a particular group is to determine whether an extracted face matches a person belonging to a particular organization.

Moreover, a person may be extracted from a target image, and a determination process may be performed in terms of the height, gender, clothes, body orientation, hand and foot positions, etc.

Moreover, a vehicle may be extracted from a target image, and a determination process may be performed in terms of the kind of the vehicle, speed, plate number, name of the vehicle, etc.

Moreover, an animal may be extracted from a target image, and a determination process may be performed in terms of the kind of the animal, color of the fur, size, etc.

Moreover, a plant may be extracted from a target image, and a determination process may be performed in terms of the kind of the plant, freshness, price, etc.

Furthermore, a food may be extracted from a target image, and a determination process may be performed in terms of the kind of the food, calorie, price, etc.

As described above, the present invention is applicable to any image processing as far as the image processing includes a plurality of tasks.

Moreover, the present invention is applicable to processing other than image processing. In other words, the present invention is widely applicable to processing including a plurality of tasks that can be performed by distributed processing.

At least part of the information processing apparatus 1 explained in the embodiments may be configured with hardware or software. When it is configured with software, a program that performs at least part of the functions of the information processing apparatus 1 may be stored in a storage medium such as a flexible disk and CD-ROM, and then installed in a computer to run thereon. The storage medium may not be limited to a detachable one such as a magnetic disk and an optical disk but may be a standalone type such as a hard disk drive and a memory.

Moreover, a program that achieves the function of at least part of the information processing apparatus 1 may be distributed via a communication network (including wireless communication) such as the Internet. The program may also be distributed via an online network such as the Internet or a wireless network, or stored in a storage medium and distributed under the condition that the program is encrypted, modulated or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
a communication part configured to communicate with other communication apparatuses via a network;
a message receiving part configured to receive messages distributed to the network by the other communication apparatuses, via the communication part;
a network-information acquiring part configured to acquire network information on communication with the other communication apparatuses which has transmitted the messages received by the message receiving part;
a peripheral-apparatus information managing part configured to manage the network information acquired by the network-information acquiring part and the message received by the message receiving part, for each of the other communication apparatuses connected to the network;
a task accepting part configured to accept tasks requested by the other communication apparatuses via the communication part;
a task allocating part configured, based on the messages received by the message receiving part and the network information, to allocate tasks to be performed and to request the other communication apparatus for a task allocated to the other communication apparatus via the communication part;
a task processing part configured to execute a task allocated by the task allocating part;
a process-related information generating part configured to generate process-related information that includes at least one of a processing capability of the task processing part and a processing load of the task processing part; and
a message transmitting part configured to generate a message that includes the process-related information and transmit the message including the process-related information to the other communication apparatuses via the communication part and the network.

2. The information processing apparatus of claim 1 further comprising a peripheral-apparatus database part in which the network information for each of the other communication apparatuses, managed by the peripheral-apparatus information managing part, is registered in association with each of the other communication apparatuses.

3. The information processing apparatus of claim 1, wherein the network information includes at least one piece of information among processing capabilities of the other communication apparatuses, processing loads of the other communication apparatuses, a connection mode with the other communication apparatuses, communication quality, a communication delay, a packet error rate, the number of hops and signal strength.

4. The information processing apparatus of claim 1, wherein the task allocating part gives an order of priority to the other communication apparatuses based on a predetermined condition when allocating tasks to the other communication apparatuses.

5. The information processing apparatus of claim 4, wherein the predetermined condition includes at least one of a communication time with each of the other communication apparatuses and a task processing time of each of the other communication apparatuses.

6. The information processing apparatus of claim 4, wherein, when the task accepting part receives a response of not being able to process a task from any of the other communication apparatuses to which the task has been allocated, the task accepting part updates the order of priority given to the other communication apparatuses to search for a communication apparatus again to which the task is to be allocated.

7. The information processing apparatus of claim 1 further comprising an image acquiring part configured to acquire an image to be processed,
wherein the task allocating part performs allocation of tasks for image processing,
the task processing part executes image processing allocated by the task allocating part and image processing accepted by the task accepting part,
the process-related information generating part generates process-related information that includes at least one of an image processing capability of the task processing part and a processing load of the task processing part in performing image processing, and
the message transmitting part generates the message that includes a request for processing a task for image processing allocated by the task processing part to the other communication apparatuses connected to the network.

8. The information processing apparatus of claim 7, wherein tasks to be allocated by the task allocating part include a task of a face recognizing process for humans contained in an image and a task of a gender determining process for face-recognized humans.

9. The information processing apparatus of claim 7, wherein the task allocating part allocates a task related to a process of dividing an image into a plurality of regions to the task processing part and allocates tasks related to image processing in respective divided regions to the other communication apparatuses connected to the network.

10. The information processing apparatus of claim 1, wherein the process-related information generating part comprises:
a processing-capability acquiring part configured to acquire a processing capability unique to the apparatus, which is not affected by a processing load; and
a processing-load generating part configured to generate dynamic processing load information that varies depending on a processing load, the processing load information including at least one among the current processing load, the tendency of processing load, and the prediction of future processing load,
wherein the process-related information includes the processing capability unique to the apparatus acquired by the processing-capability acquiring part and the dynamic processing load information generated by the processing-load generating part.

11. The information processing apparatus of claim 10, wherein the dynamic processing load information includes a processing load of the task processing part, a load of network processing caused when the communication part communicates with the other communication apparatuses via the network, and processing loads of all of the other communication apparatuses that are connected to the network to perform task distributed processing.

12. The information processing apparatus of claim 1, wherein the communication part supplies the message included in a message of a routing protocol to the message receiving part and supplies information including routing information contained in the message of the routing protocol and signal strength at the time of reception to the network-information acquiring part.

13. A camera comprising:
an image capturing part configured to capture at least one of a moving image and a still image;
an image storage part configured to store at least one of the moving and still image captured by the image capturing part;
a communication part configured to communicate with other communication apparatuses via a network;
a message receiving part configured to receive messages distributed to the network by the other communication apparatuses, via the communication part;
a network-information acquiring part configured to acquire network information on communication with the other communication apparatuses which has transmitted the messages received by the advertisement receiving part;
a peripheral-apparatus information managing part configured to manage the network information acquired by the network-information acquiring part and the message received by the message receiving part, for each of the other communication apparatuses connected to the network;
a task accepting part configured to accept tasks requested by the other communication apparatuses via the communication part;
a task allocating part configured, based on the messages received by the message receiving part and the network information, to perform allocation of tasks to be performed and to request another communication apparatus for a task allocated to the other communication apparatus via the communication part;
a task processing part configured to execute a task allocated by the task allocating part;
a process-related information generating part configured to generate process-related information that includes at least one of a processing capability of the task processing part and a processing load of the task processing part; and
a message transmitting part configured to generate a message that includes the process-related information and transmit the message including the process-related information to the other communication apparatuses via the communication part and the network.

14. The camera of claim 13 further comprising a peripheral-apparatus database part in which the network information for each of the other communication apparatuses, managed by the peripheral-apparatus information managing part, is registered in association with each of the other communication apparatuses.

15. The camera of claim 13, wherein the network information includes at least one piece of information among processing capabilities of the other communication apparatuses, processing loads of the other communication apparatuses, a connection mode with the other communication apparatuses, communication quality, a communication delay, a packet error rate, the number of hops and signal strength.

16. The camera of claim 13, wherein the task allocating part gives an order of priority to the other communication apparatuses based on a predetermined condition when allocating tasks to the other communication apparatuses.

17. The camera of claim 16, wherein the predetermined condition includes at least one of a communication time with each of the other communication apparatuses and a task processing time of each of the other communication apparatuses.

18. The camera of claim 16, wherein, when the task accepting part receives a response of not being able to process a task from any of the other communication apparatuses to which the task has been allocated, the task accepting part updates the order of priority given to the other communication apparatuses and search for a communication apparatus again to which the task is to be allocated.

19. The camera of claim 13 further comprising an image acquiring part configured to acquire an image to be processed,
wherein the task allocating part performs allocation of tasks for image processing,
the task processing part executes image processing allocated by the task allocating part and image processing accepted by the task accepting part,
the process-related information generating part generates process-related information that includes at least one of an image processing capability of the task processing part and a processing load of the task processing part in performing image processing, and
the message transmitting part generates the message that includes a request for processing a task for image processing allocated by the task processing part to the other communication apparatuses connected to the network.

20. An information processing method comprising the steps of:
receiving messages distributed to a network by other communication apparatuses, via a communication part;
acquiring network information on communication with the other communication apparatuses which has transmitted the received messages;
managing the acquired network information and the received message, for each of the other communication apparatuses connected to the network;
accepting tasks requested by the other communication apparatuses via the communication part;
based on the received messages and the managed network information, performing allocation of tasks to be performed and requesting another communication apparatus for a task allocated to the other communication apparatus via the communication part;
executing an allocated task and the accepted tasks at a task processing part;
generating process-related information that includes at least one of a processing capability of the task processing part and a processing load of the task processing part; and
generating a message that includes the process-related information and transmitting the message including the process-related information via the communication part and the network.
